(19) United States
(12) Patent Application Publication
(10) Pub. No.: US 2008/0105607 A1
(43) Pub. Date: May 8, 2008

(54) Multiple Cartridge, Cartridge Array Frame, and Recovery Container

(75) Inventors: Keiji Shigesada, Kanagawa (JP); Morio Fujiwara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: Fujifilm Corporation, Minato-ku, Tokyo (JP)

(21) Appl. No.: 11/662,195

(22) PCT Filed: May 19, 2005
(86) PCT No.: PCT/JP05/09595

§ 371 Date: Mar. 8, 2007

(30) Foreign Application Priority Data
Sep. 30, 2004 (JP) 2004-286238

(51) Int. Cl. B01D 63/06; B01L 9/00; B01L 3/00

(52) U.S. Cl. 210/321.78; 422/104; 422/102

(57) ABSTRACT

In order to prevent a leakage of pressurized air when a force of 12 N is applied, a multiple cartridge (A) of the present invention plurally provides porous membrane cartridges (1) side by side by a link piece (5), each of which has a tubular barrel (10) having openings (11a, 11b) at a top end portion (13) and rear end portion thereof; a cap (20) that is formed like a tube having a fit-in portion (22) for fitting outside the top end portion, and abuts an opening edge (14) of the top end portion, and has a sandwich face (24) for sandwiching a porous membrane (F) between the cap and the barrel; and the porous membrane sandwiched between the opening edge of the barrel and the cap.

### TECHNICAL FIELD

The present invention relates to a multiple cartridge having a plurality of porous membrane cartridges used for filtrating liquid and the like, a cartridge array frame for arraying the multiple cartridge, and a recovery container for recovering an effluent or extraction liquid.

### BACKGROUND ART

A porous membrane is widely used in a laboratory and a factory for filtrating liquid and adsorbing a specific substance in liquid. And in utilizing the porous membrane for such the purpose, it is necessary to hold the porous membrane on the way of a passage where the liquid passes. As this holding method is generally used a method of sandwiching the porous membrane between two members having the passage where the liquid passes, and thus holding it.

Because such a porous membrane is generally used in an accurate experiment and measurement, clean one is requested, and if used once, it is usually changed. Therefore, in a point of cleanliness and that of usability in use, it is convenient to make a cartridge a state of holding the porous membrane and being able to pass liquid. As such a porous membrane cartridge is known such a nucleic acid refining unit described in paragraphs 0010 to 0020 and FIG. 1 of JP-A-2002-345465.

Whereas, generally in an extraction process of nucleic acids and the like and in an amplification process and an analysis process thereafter, porous membrane cartridges are formed of a multiple cartridge of format of 96 pieces of 8 pieces×12 rows. Consequently, although it can be thought to integrally mold the porous membrane cartridges into the multiple cartridge of format of 96 pieces, a metal mold, equipment, and working equipment become a large scale and result in a cost increase. On the other hand, it is very troublesome to array a porous membrane cartridge one by one in a frame where porous membrane cartridges of 8 pieces×12 rows can be accommodated.

Therefore, a multiple cartridge can be thought where eight or twelve porous membrane cartridges are provided side by side. However, if contacting an extractor for extracting extraction liquid from a rear end side of the multiple cartridge and attempting to pass pressurized air, it turns out that there is some case that a bending occurs in the multiple cartridge by the pressurizing, and that thereby a leakage of the pressurized air occurs.

### DISCLOSURE OF THE INVENTION

Consequently, the present invention aims to provide a multiple cartridge where a bending does not occur and thereby a leakage of pressurized air does not occur, even if the multiple cartridge is pressurized by equipment for extracting extraction liquid and the like.

In addition, the invention aims to provide a cartridge array frame for holding and arraying a multiple cartridge so that in the multiple cartridge a bending does not occur and thereby a leakage of pressurized air does not occur, even if the multiple cartridge is pressurized by equipment for extracting extraction liquid and the like.

Furthermore, the invention aims to provide a recovery container for holding a multiple cartridge and recovering extraction liquid and the like so that in the multiple cartridge a bending does not occur and thereby a leakage of pressurized air does not occur, even if the multiple cartridge is pressurized by equipment for extracting the extraction liquid and the like.

In order to solve the problem, a multiple cartridge of the present invention is configured as follows:

That is, the multiple cartridge of the invention is a cartridge that plurally comprises porous membrane cartridges side by side in a row for holding each porous membrane within a tube of a tubular body thereof, which has an opening at a top end portion and rear end portion thereof, and when force applied toward a top end portion is 12 N from each rear end portion of the plurality of the porous membrane cartridges, a bending amount thereof in a downward direction is not more than 1 mm.

In accordance with such the multiple cartridge, even if the porous membrane cartridges receive a force of 12 N in the downward direction, the bending amount in the downward direction can be suppressed to be not more than 1 mm.

Here, the reason why a force of 12 N is applied in the downward direction of the multiple cartridge is according to a fact that when passing liquid to be treated through the porous membrane cartridges configuring the multiple cartridge, it is necessary to supply pressurized air of 1.5 KPa to the porous membrane cartridges, and at this time a force of 12 N has to be applied toward each top end portion from the rear end portion of the porous membrane cartridges so as not to leak the pressurized air.

A porous membrane cartridge may comprise a tubular barrel having an opening at a top end portion and rear end portion thereof; a cap that is formed like a tube having a fit-in portion for fitting outside the top end portion, abuts with an opening edge of the top end portion, and has a sandwich face for sandwiching a porous membrane between the cap and the barrel; and the porous membrane sandwiched between the opening edge of the barrel and the cap.

In addition, an adjacent portion of each porous membrane cartridge may also be linked by a link piece along a longitudinal direction of the tubular body.

In addition, an adjacent portion of each porous membrane cartridge may also be linked by a link piece along a longitudinal direction of the barrel or the cap.

In addition, a connection portion of each porous membrane cartridge may also be thickly formed.

In addition, each adjacent tubular body may also be integrally molded.

In addition, each adjacent barrel or each adjacent cap may also be integrally molded.

In addition, assuming that a length of a link piece in a vertical direction is L (mm) and a thickness thereof is t (mm), L×t is preferably not less than 5.

Furthermore, assuming that the length of the link piece in the vertical direction is L (mm) and the thickness thereof is t (mm), L×t is more preferably not less than 7.

In addition, in order to solve the problem, a cartridge array frame of the present invention is configured as follows:

That is, the cartridge array frame of the present invention is the frame for arraying in a plurality of rows multiple cartridges, where porous membrane cartridges for holding each porous membrane within a tube of a thereof having each opening at an top end portion and rear end portion thereof are plurally provided side by side in a row and integrally configured: the frame comprises a frame body having a rectangular opening, where one pair of sides thereof corresponds to a length in a horizontal direction of each of the multiple cartridges; a plurality of first holding portions that are provided inside the other pair of sides of the opening and hold a side portion of the multiple cartridge; and a second holding portion that is provided inside one pair of sides and/or the other pair of sides of the opening and holds the tubular body of the multiple cartridge.

Even if because such the cartridge array frame has the second holding portion for holding the tubular body other than ends of the multiple cartridge, the porous membrane cartridge receives a force of 12 N in a downward direction thereof, a bending of the multiple cartridge in the downward direction can be suppressed.

In addition, the cartridge array frame may be configured as follows:

That is, the cartridge array frame of the present invention is the frame for arraying in a plurality of rows multiple cartridges, where porous membrane cartridges for holding each porous membrane within a tube of a thereof having each opening at an top end portion and rear end portion thereof and for linking an adjacent portion of each of the porous membrane cartridges by a link piece along a longitudinal direction of the tubular body are plurally provided side by side in a row and integrally configured: the frame comprises a frame body having a rectangular opening, where one pair of sides thereof corresponds to a length in a horizontal direction of each of the multiple cartridges; a plurality of first holding portions that are provided inside the other pair of sides of the opening and hold a side portion of the multiple cartridge; and a third holding portion that is provided inside one pair of sides and/or the other pair of sides of the opening and holds the link piece of the multiple cartridge.

Even if because such the cartridge array frame has the third holding portion for holding the link piece of the multiple cartridge, the porous membrane cartridge receives a force of 12 N in a downward direction thereof, a bending of the multiple cartridge in the downward direction can be suppressed.

In addition, in order to solve the problem, a recovery container of the present invention is configured as follows:

That is, the recovery container of the present invention is the container for recovering extraction liquid or an effluent discharged from matrix-like multiple cartridges arranged in a cartridge array frame where multiple cartridges, where porous membrane cartridges for holding each porous membrane within a tube of a thereof having an opening at a top end portion and rear end portion thereof are plurally provided side by side in a row and integrally configured, are arrayed in a plurality of rows: the container comprises a container body having a plurality of openings corresponding to the matrix-like multiple cartridges and a fourth holding portion for holding each tubular body of the multiple cartridges formed at edges of the openings.

Even if because such the recovery container has the fourth holding portion for holding each tubular body other than those at ends of the porous membrane cartridges, each of the porous membrane cartridge receives a force of 12 N in a downward direction thereof, a bending of the multiple cartridge in the downward direction can be suppressed.

In accordance with the present invention, because if the porous membrane cartridge receives a force of 12 N in the downward direction, the bending of the multiple cartridges in the downward direction can be suppressed, a leakage of pressurized air can be prevented.

### BRIEF DESCRIPTION OF DRAWINGS

FIG. 1(a) is a front view of a multiple cartridge related to a first embodiment of the present invention; FIG. 1(b) is a top view of the multiple cartridge related to the first embodiment; and FIG. 1(c) is a perspective view of the multiple cartridge related to the first embodiment.

FIG. 2 is a perspective view showing a part of the multiple cartridge related to the first embodiment.

FIG. 3 is a perspective view showing a variation example of a multiple cartridge.

FIG. 4 is a perspective view showing a variation example of a multiple cartridge.

FIG. 5 is an exploded perspective view of a porous membrane cartridge related to the first embodiment.

FIG. 6 is a section view of a porous membrane cartridge related to the first embodiment.

FIG. 7 is an enlarged section perspective view of a cap related to the first embodiment.

FIG. 8 is a perspective view for illustrating a state that multiple cartridges related to the first embodiment are arrayed in a cartridge array frame.

FIG. 9 is a perspective view for illustrating a state that multiple cartridges related to the first embodiment are arrayed in a cartridge array frame.

FIG. 10 is a perspective view showing a use state of a cartridge array frame related to a second embodiment.

FIG. 11 is a perspective view showing a use state of a cartridge array frame related to the second embodiment.

FIG. 12 is a perspective view showing a variation example of a cartridge array frame related to the second embodiment.

FIG. 13 is a perspective view showing a variation example of a cartridge array frame related to the second embodiment.

FIG. 14 is a partial section view of a recovery container related to a third embodiment.

FIG. 15 is a perspective view of the recovery container related to the third embodiment.

FIG. 16 is a perspective view of the recovery container related to the third embodiment.

### MODE(S) FOR CARRYING OUT THE INVENTION

### First Embodiment

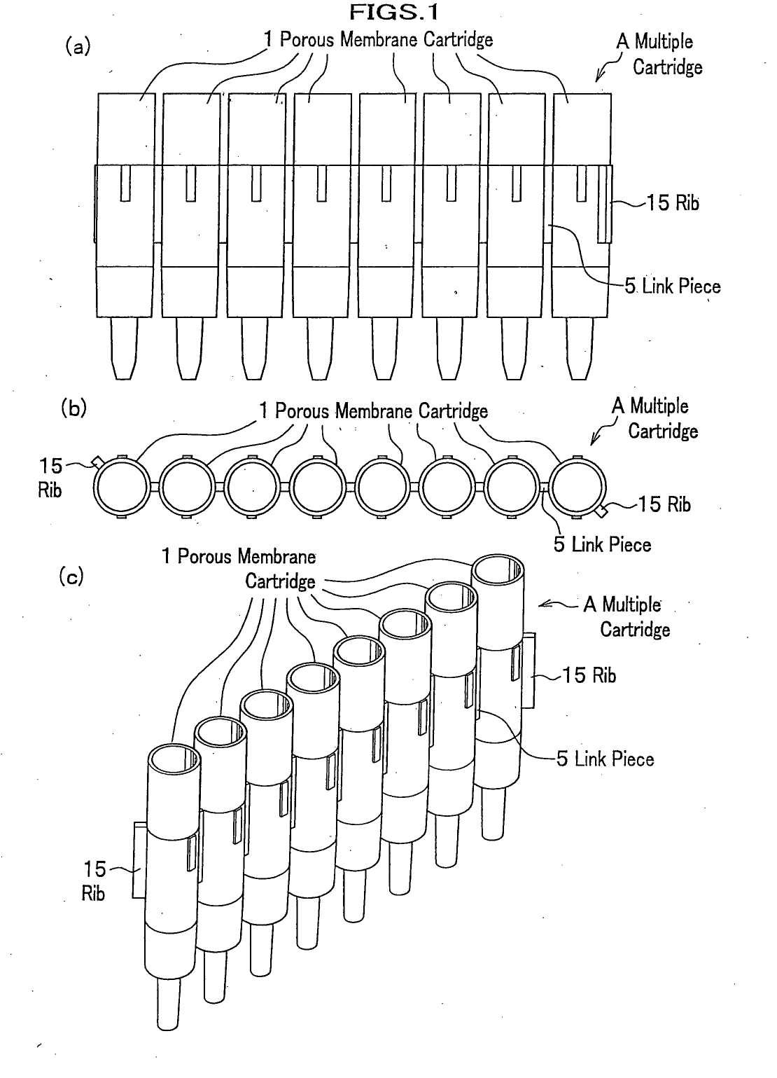

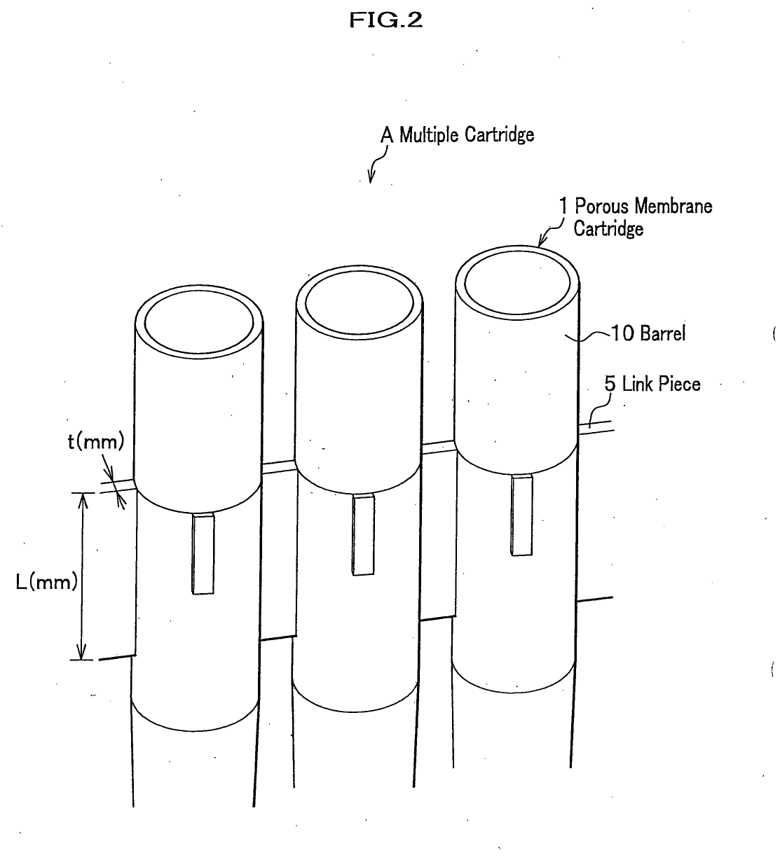

Next will be described a best mode for embodying the present invention, referring to FIGS. 1 to 9 as needed. Meanwhile, although in the embodiment is described a case that a multiple cartridge is used in an extraction of nucleic acids as an application thereof, the application is not limited thereto.

As shown in FIGS. 1(a) to (c), in a multiple cartridge A related to the first embodiment, eight porous membrane cartridges 1 are linked side by side by link pieces 5, respectively. The link pieces 5 are composed of a resin such as sheet-form polypropylene and have such a strength that a bending of the multiple cartridge A in a downward direction thereof becomes not more than 1 mm even if a force of 12 N is applied toward a rear end portion from an top end portion thereof. Meanwhile, in the embodiment a side of the multiple cartridge A (barrel 10 and cap 20) where liquid flows in is called a rear end side; a side thereof where the liquid is pushed out is called a top end side. In addition, assuming that a length of each of the link pieces 5 in a vertical direction is L (mm) and a thickness thereof is t (mm), L×t is preferably not less than 5, more preferably not less than 7. As shown in FIG. 5, a porous membrane cartridge 1 comprises a porous membrane F and the barrel 10 and cap 20 that hold the porous membrane F and form a passage where liquid passes. In addition, in each porous membrane cartridge 1 at both ends of the multiple cartridge A is formed a rib 15 at a position separated by approximately 135 degrees in a horizontal direction for the link piece 5. The rib 15 abuts with an upper portion of a cartridge array frame B described later where the multiple cartridge A is inserted.

Each barrel 10 comprises a cylindrical main body portion 12, the link piece 5 formed on a side face and linked with another barrel 10 (porous membrane cartridge 1), a cylindrical top end portion 13 connected to the main body portion 12, and further comprises an opening 11a at the top end portion 13 and an opening 11b at the rear end portion of the main body portion 12. Therefore, liquid can pass from the opening 11b to the opening 11a. An outer diameter of the top end portion 13 is designed to be one size smaller than that of the main body portion 12. In addition, a thickness of the barrel 10 is preferably not less than 0.5 mm.

As shown in FIG. 5, the cap 20 comprises a cylindrical fit-in portion 22, and a nozzle 23 connected to a top end side of the fit-in portion 22.

At a top of the nozzle 23 is formed an opening 21a, also at a rear of the fit-in portion 22 is formed an opening 21b, and thus liquid can pass from the rear toward top of the cap 20. A thickness of the nozzle 23 is preferably not less than 0.5 mm.

An inner diameter of the fit-in portion 22 is formed to be a diameter that can fit the outer diameter of the top end portion 13 of the barrel 10.

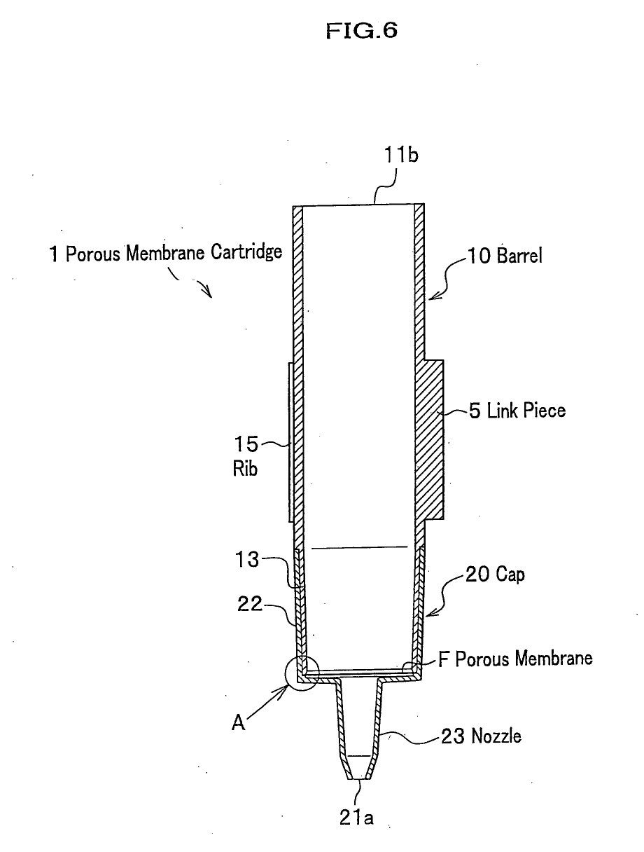

And as shown in FIG. 6, by fitting the top end portion 13 of the barrel 10 in the fit-in portion 22 of the cap 20 in a state of the porous membrane F being kept inside the fit-in portion 22 of the cap 20, the porous membrane F can be sandwiched between the cap 20 and the barrel 10.

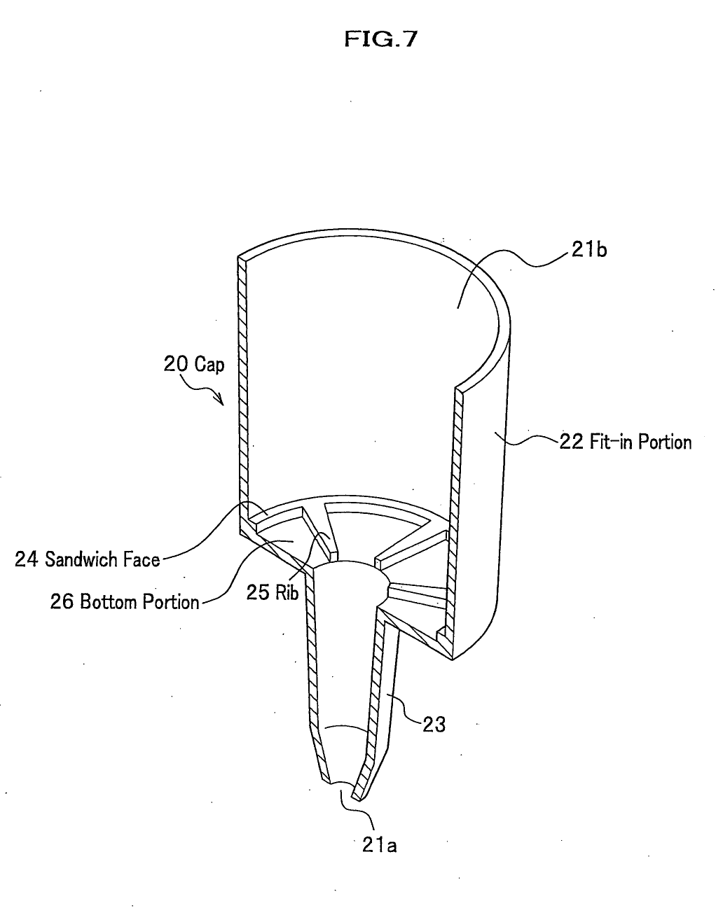

As shown FIG. 7, in the cap 20 are formed six (only three shown) radial ribs 25 at a bottom portion 26 of the fit-in portion 22 connected to the nozzle 23 through the fit-in portion 22. In addition, at an outer circumferential edge of the bottom portion 26 is circumferentially formed a sandwich face 24, which is higher by one step than the bottom portion 26 so as to be a same height as an upper face of the ribs 25.

The sandwich face 24 is a face for sandwiching the porous membrane F between itself and the opening edge 14 (see FIG. 5) corresponding to an edge of the opening 11a of the barrel 10.

The ribs 25 are formed to be the same height as the sandwich face 24, thereby support the porous membrane F arranged at the bottom portion 26 within the cap 20, and prevent the porous membrane F from elongating and breaking by a liquid flow from the rear (opening 21b) to the top (opening 21a). In addition, the ribs 25 are radially formed, and thereby liquid is designed to smoothly flow into the nozzle 23 when making the liquid flow from the top to the rear.

Meanwhile, although the barrel 10 and the cap 20 are composed, for example, of polypropylene, it is not limited thereto. When fixing the barrel 10 and the cap 20 by ultrasonic deposition, a thermoplastic resin where the ultrasonic deposition can be applied is available. In addition, when fixing them by an adhesive, a material that can be adhered by the adhesive is available.

The porous membrane F is the membrane composed of an organic polymer and is formed to be a circular form approximately matching the inner diameter of the cap 20 and the outer diameter of the top end portion 13 of the barrel 10. As a material of the porous membrane F is suitable, for example, a surface saponification matter of an acetylcellulose. As the acetylcellulose, although any of a mono-acetylcellulose, di-acetylcellulose, and tri-acetylcellulose is available, the tri-acetylcellulose is especially desirable.

Meanwhile, as a common filter can also be used a porous membrane composed of PTFE (polytetrafluoroethylene), polyamide, polypropylene, polycarbonate, and the like.

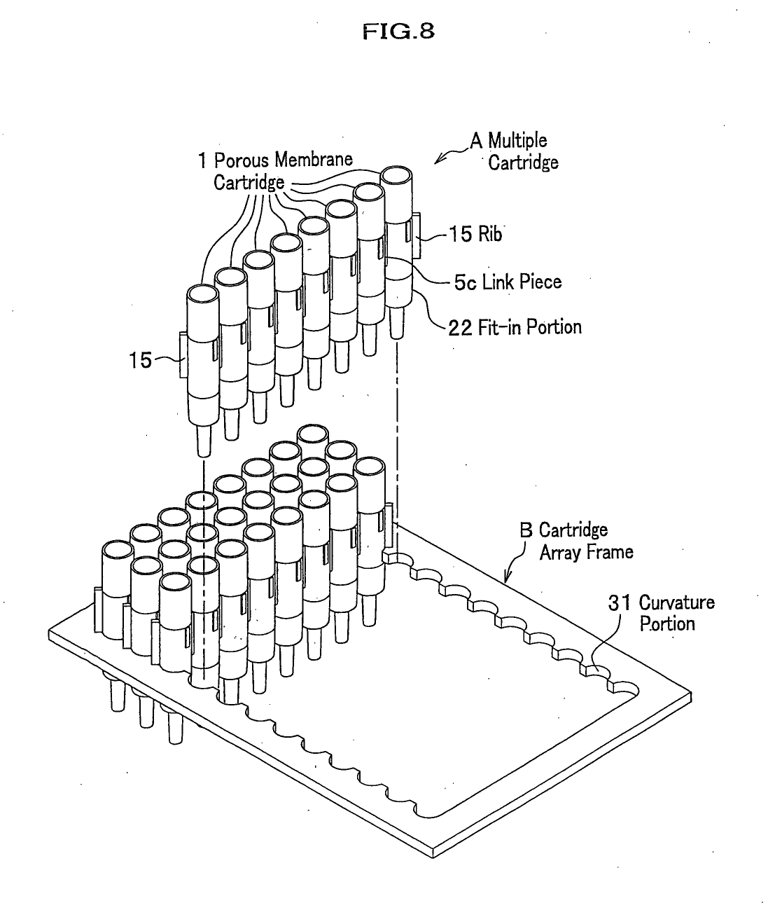

Next will be described the cartridge array frame B where the multiple cartridges A is arrayed, referring to FIG. 8. The cartridge array frame B is a rectangular frame body. On one pair of inside faces of the cartridge array frame B are formed curvature portions 31 for fitting in side faces of the multiple cartridge A. Meanwhile, the cartridge array frame B is held by a holding mechanism not shown.

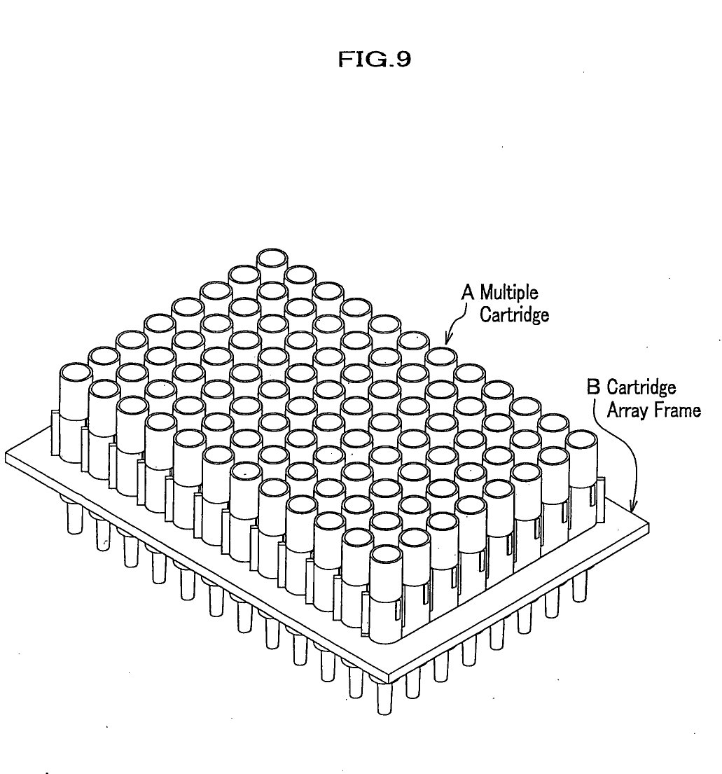

As shown in FIGS. 8 and 9, each multiple cartridge A fits in the cartridge array frame B. The fit-in portions 22 of the multiple cartridge A fit in the curvature portions 31 of the cartridge array frame B. The ribs 15 of the multiple cartridge A abut with the upper portion of the cartridge array frame B.

The multiple cartridge A is used as follows:

Firstly, as sample solutions containing nucleic acids, prepare body fluids such as a whole blood, plasma, serum, urine, human waste, semen, and saliva taken as analytes; or solutions adjusted from biotic materials such as a soluble matter and homogenate of a vegetable (or its part), an animal (or its part), and the like. Treat these solutions with a water solution containing a reagent, which solves a cell membrane and solublizes the nucleic acids. Thus the cell membrane and nucleic membrane are solved, and the nucleic acids are dispersed in the water solution. For example, when a sample is a whole blood, red blood cells and various proteins are removed and white blood cells and nucleic membranes are solved by incubation of 10 minutes at 60 degrees Celsius in a state of addition of Guanidine Hydrochloride, Triton-X100, and Protease K (manufactured by SIGMA Corp.).

A sample solution is completed by adding a water soluble organic solvent, for example, ethanol in the water solution where the nucleic acids are thus dispersed. Introduce the sample solution from the rear end portion of the main body portion 12 of the barrel 10 of the multiple cartridge A, then introduce pressurized air into the multiple cartridge A, and contact an apparatus for applying a force of 12 N at the rear end portion of the main body portion 12 of the barrel 10 with the rear end portion. And while supplying pressurized air of 1.5 KPa toward the opening 21a of the top end of the nozzle 23 from the opening 11b of the rear end side of the porous membrane cartridge 1 and applying a force of 12 N, pass the sample solution. Thus the nucleic acids in the sample solution are adsorbed by the porous membrane F. At this time the multiple cartridge A does not bend by not less than 1 mm even if a force of 12 N is applied.

Next, while supplying pressurized air of 1.5 KPa toward the opening 11b of the rear end side of the porous membrane cartridge 1 from the opening 21a of the top end of the nozzle 23 and applying a force of 12 N, pass a nucleic-acid-washing buffer solution. Although the nucleic-acid-washing buffer solution does not desorb nucleic acids adsorbed on the porous membrane F, it has a composition of desorbing impurities and consists of a solution containing a main agent and a buffer agent, and a surfactant as needed. As the main agent is preferable a solution containing ethanol, Tris, and Triton-X100. By this operation, from the porous membrane F are removed impurities other than the nucleic acids. At this time the multiple cartridge A does not bend by not less than 1 mm same as described above, even if a force of 12 N is applied.

Next, pass purification distilled water, TE buffer, or the like toward the opening 21a (see FIG. 5) from the opening 11b, desorb and flow the nucleic acids out of the porous membrane F, and recover a solution containing the nucleic acids that have flowed out. At this time the multiple cartridge A does not bend by not less than 1 mm same as described above, even if a force of 12 N is applied.

In accordance with the first embodiment of the present invention, because when passing liquid to be treated through each of the porous membrane cartridges 1 configuring the multiple cartridge A, the cartridge A does not bend by not less than 1 mm in a downward direction thereof even in case of a force of 12 N being applied from the rear end side to top end side of the porous membrane cartridge 1, a leakage of pressurized air can be prevented.

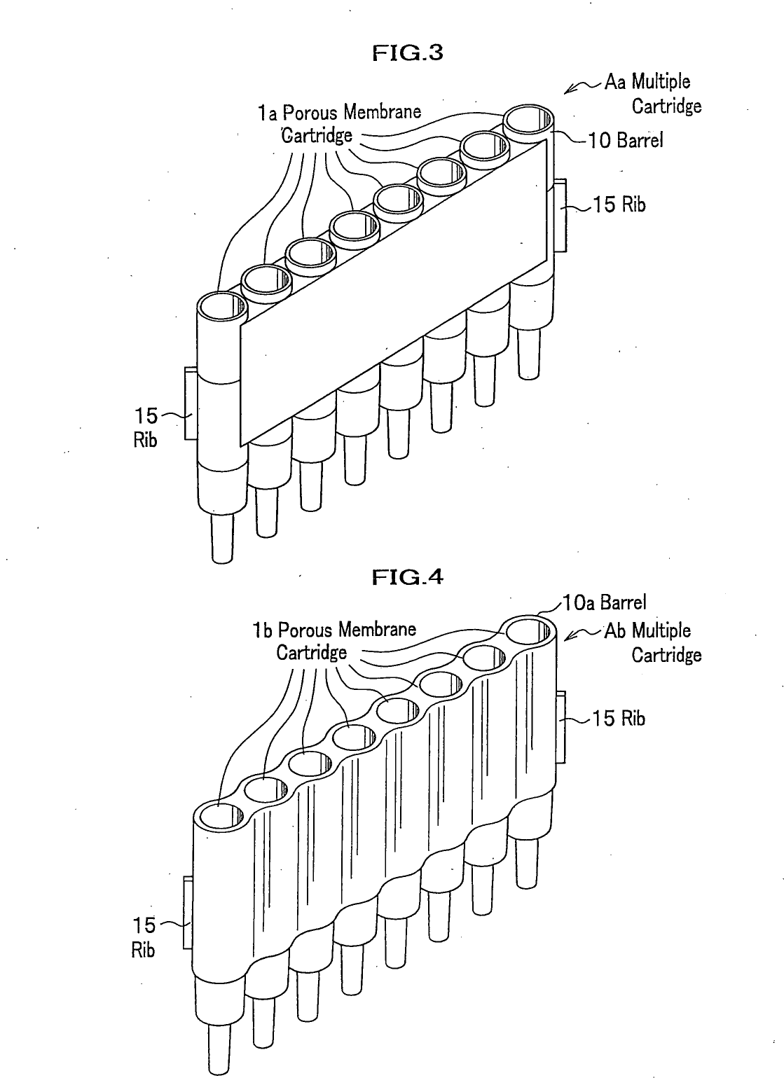

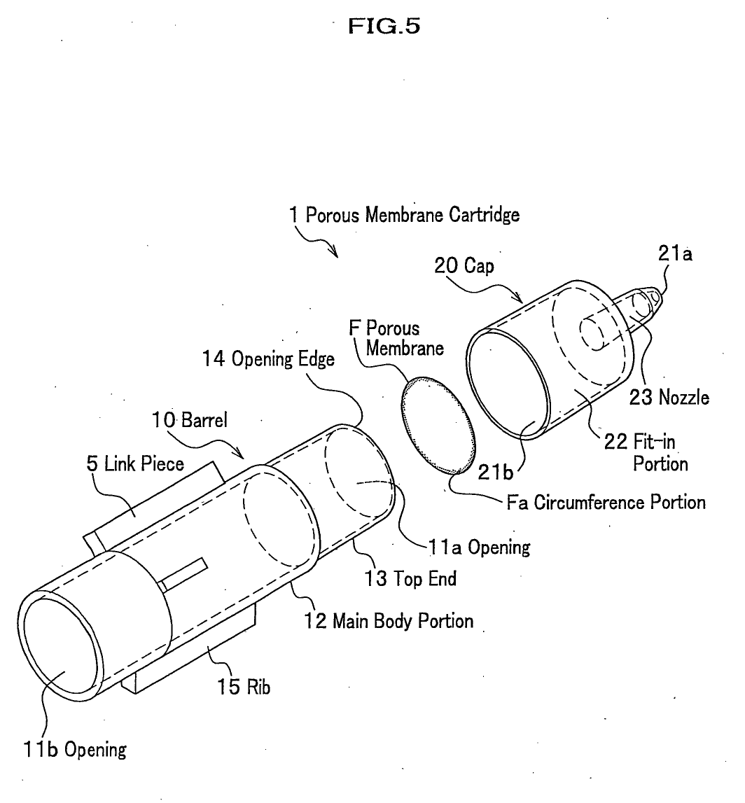

In the first embodiment of the present invention, although the porous membrane cartridges 1 configuring the multiple cartridge A are linked by the link pieces 5, it is also available, as shown in FIG. 3, to make the barrels 10 of porous membrane cartridges 1a of a multiple cartridge Aa abut each other and to make the abutment portions thick. In addition, it is also available, as shown in FIG. 4, to integrally form a barrel 10a of porous membrane cartridges 1b of a multiple cartridge Ab. In addition, in the first embodiment of the present invention, although the porous membrane cartridges 1 configuring the multiple cartridge A are linked by the link pieces 5, the caps 20 may also be linked by the link pieces 5; the caps 20 are made to abut each other, and the abutment portions may also be made thick; and in addition, the caps 20 may also be integrally molded.

In addition, in the first embodiment of the present invention, although the multiple cartridge A is configured of eight porous membrane cartridges 1, it may be configured of a plurality of porous membrane cartridges 1; it may be configured of twelve porous membrane cartridges 1.

### Second Embodiment

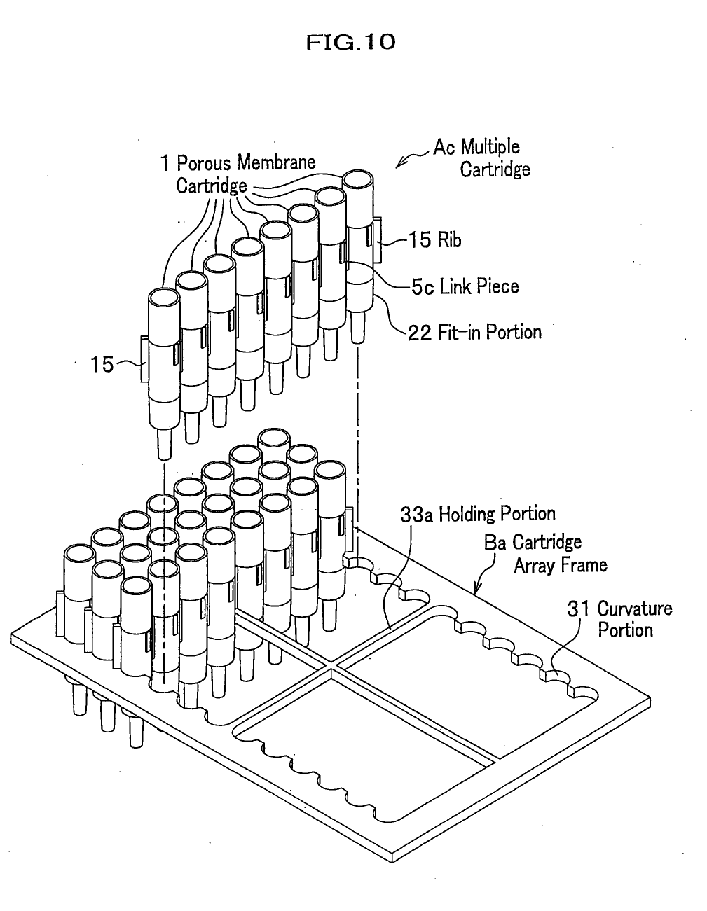

Next will be described a cartridge array frame Ba related to a second embodiment of the present invention, referring to FIGS. 10 to 13. The cartridge array frame Ba is a rectangular frame body. On one pair of inside faces of the cartridge array frame Ba are formed curvature portions 31 as a first holding portion for fitting in side faces of a multiple cartridge Ac; on inside faces of the cartridge array frame Ba is formed a substantially cross-form holding portion 33a as a third holding portion for holding link pieces 5c of multiple cartridges Ac. The holding portion 33a has such a strength that each of the multiple cartridges Ac does not excessively bend in a downward direction thereof, even if a force of 12 N is applied toward a top end side from rear end side thereof.

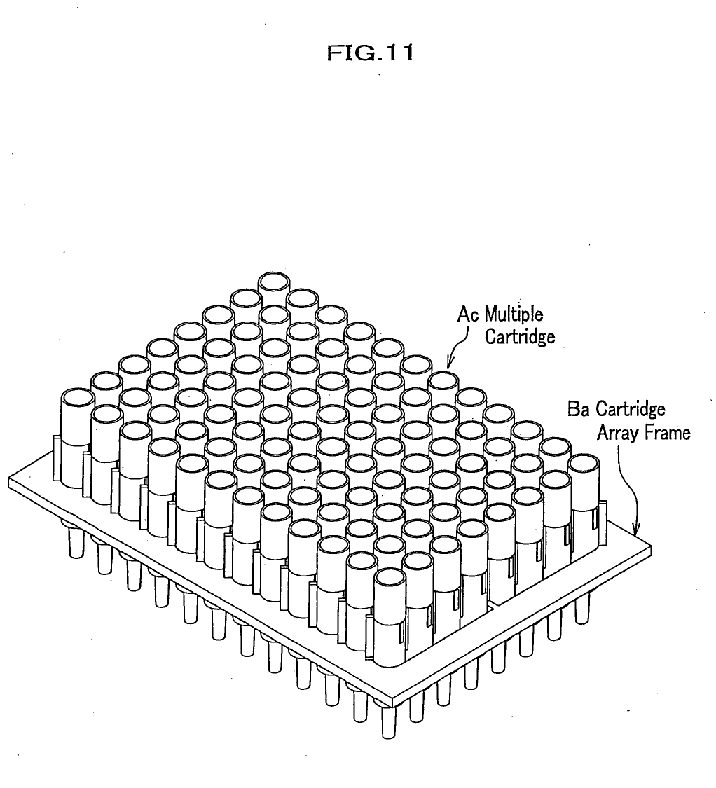

As shown in FIGS. 10 and 11, fit the multiple cartridge Ac in the cartridge array frame Ba. Here, although configured same as that of the multiple cartridge A of the first embodiment, the multiple cartridge Ac fitted in the cartridge array frame Ba may bend in a downward direction thereof not less than 1 mm in a state of not being fitting in the frame, when a force of 12 N is applied toward a top end side from rear end side of thereof. It is because the holding portion 33a of the cartridge array frame Ba supports the multiple cartridge Ac and thereby the cartridge Ac does not bend in case of a force of 12 N being applied thereto, when fitted in the cartridge array frame Ba.

In accordance with the present invention related to the second embodiment, because when passing liquid to be treated through each of the porous membrane cartridges 1 configuring the multiple cartridge Ac, the cartridge array frame Ba does not leak pressurized air and the multiple cartridge Ac does not bend by not less than 1 mm in the downward direction even in case of a force of 12 N being applied toward the top end side from rear end side of the porous membrane cartridge 1, a leakage of pressurized air can be prevented.

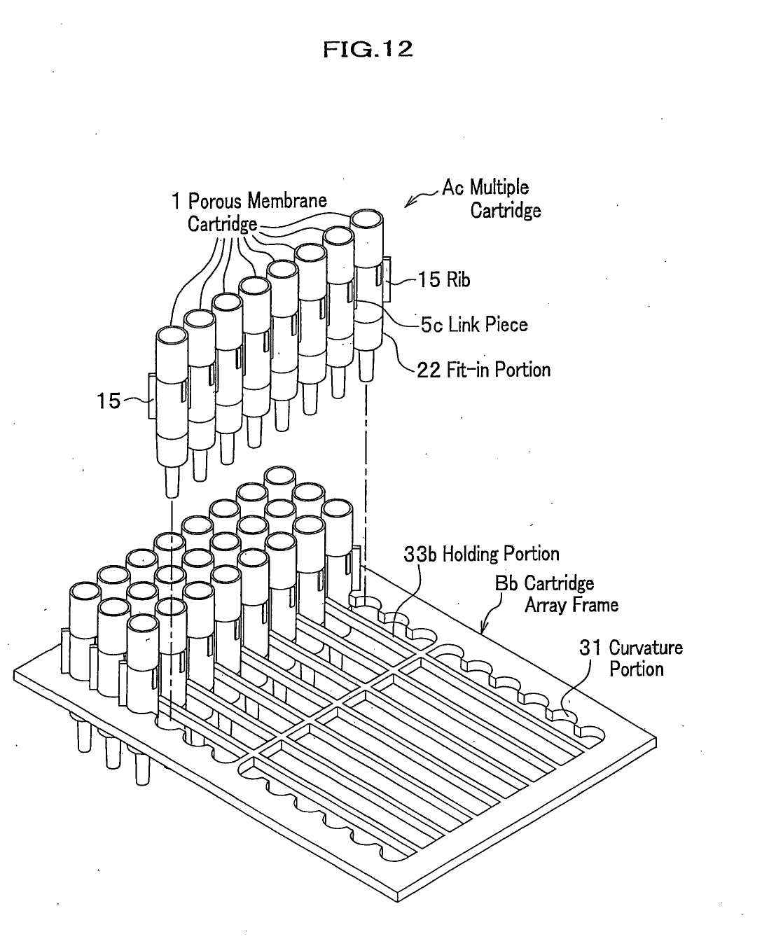

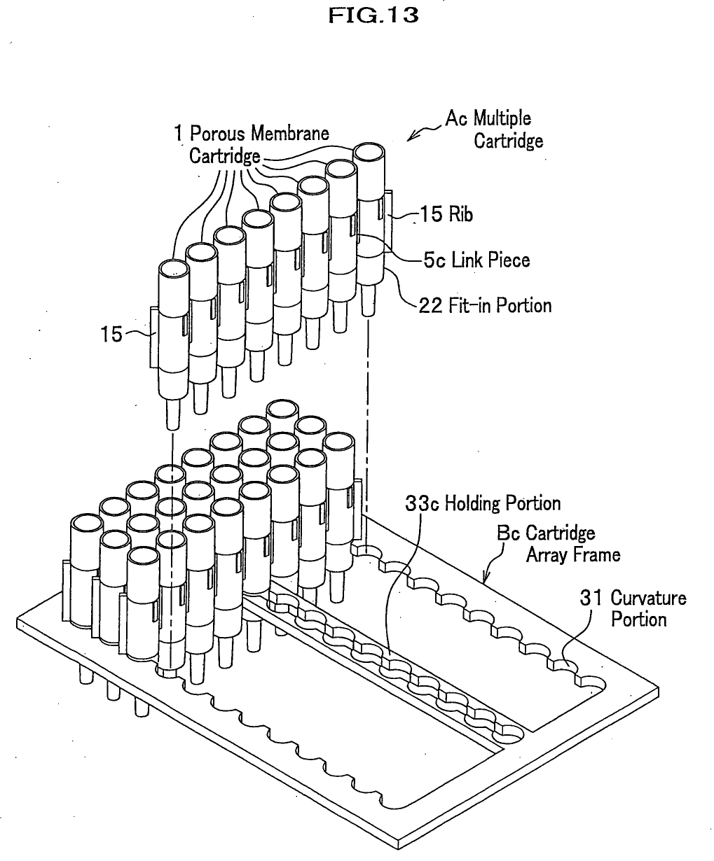

In the second embodiment, although the holding portion 33a of the cartridge array frame Ba is made a cross-form, as shown in FIG. 12, holding portions 33b provided inside the other pair of sides of a cartridge array frame Bb may also be arranged for every link pieces 5c. In addition, a holding portion of a cartridge array frame may also be a lattice form. In addition, a holding portion of a cartridge array frame may also be formed at one pair or the other of sides thereof only. In addition, as shown in FIG. 13, a holding portion (second holding portion) 33c of a cartridge array frame Bc mat be such a portion as the fit-in portion 22 of the cap 20 is fitted therein. Furthermore, a holding portion of a cartridge array frame may also be a frame where the barrel 10 and the like are fitted therein.

### Third Embodiment

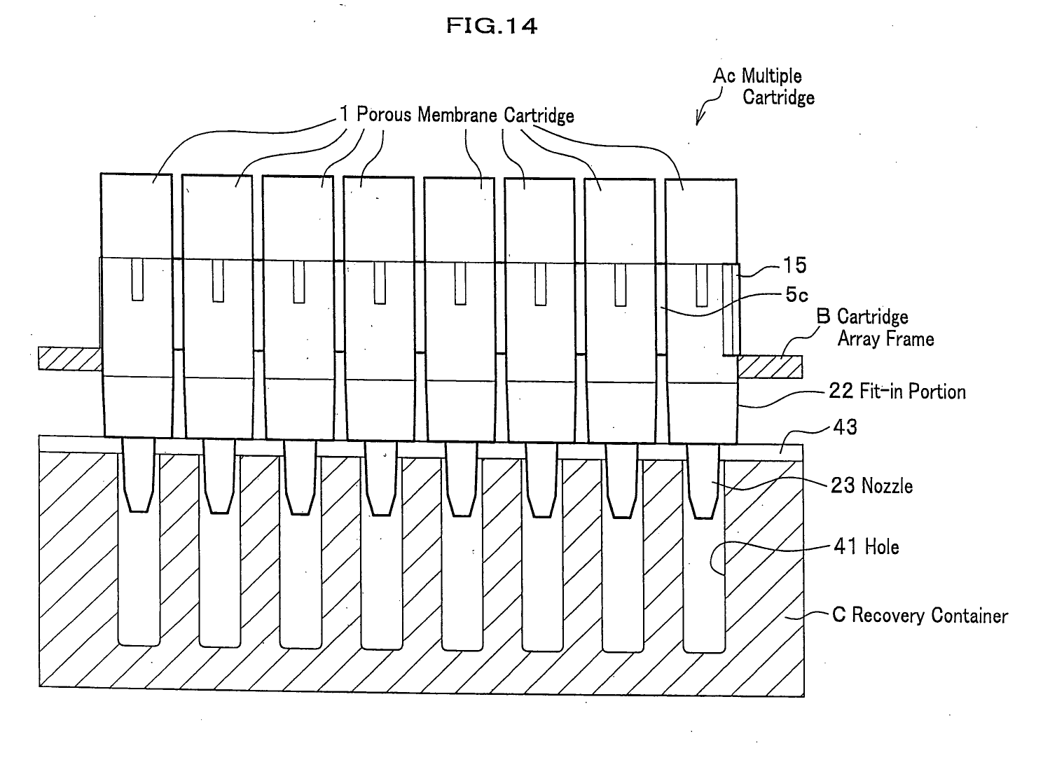

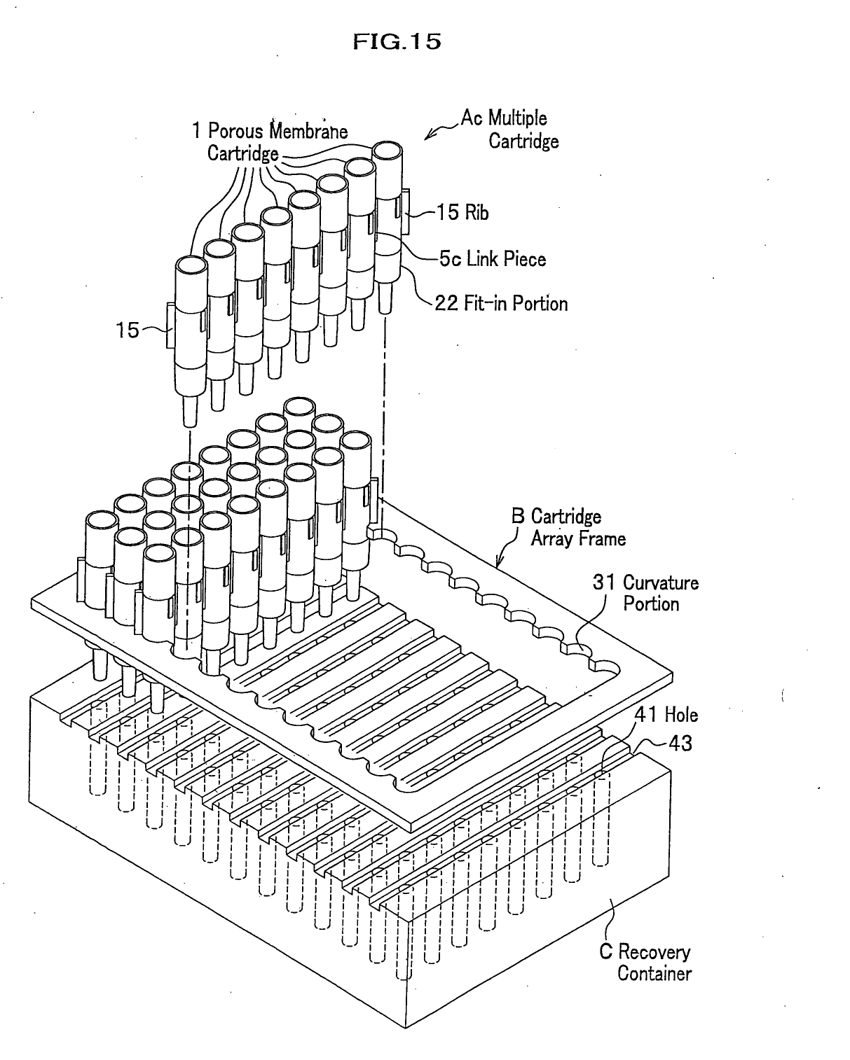

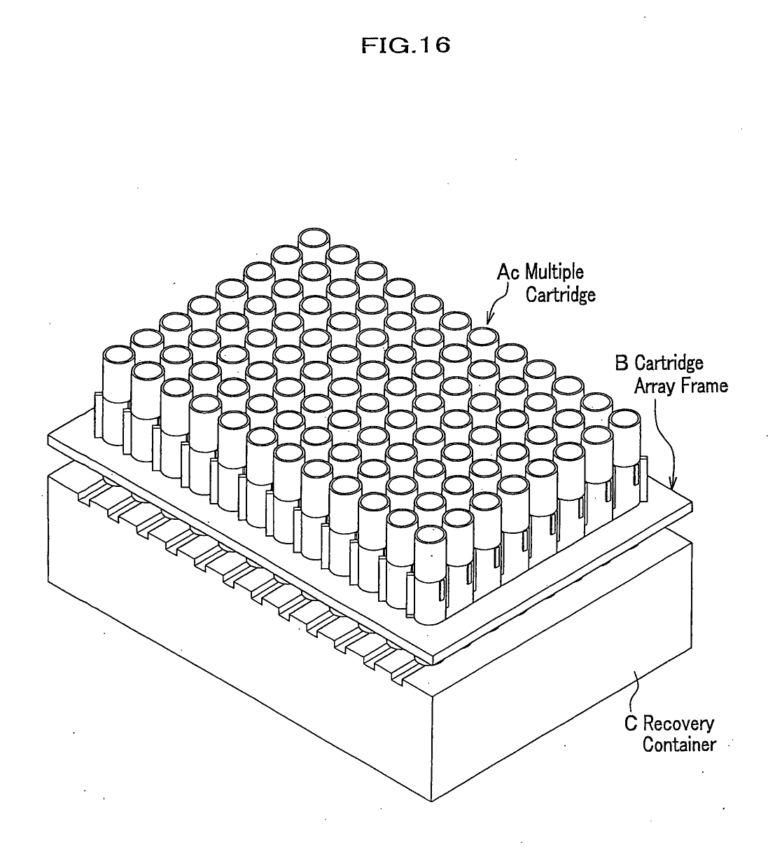

Next will be described a recovery container related to a third embodiment of the present invention, referring to FIGS. 14 to 16. As shown in FIGS. 14 and 15, a recovery container C is a substantial cuboid, and eight holes 41 per row are formed in twelve columns. A diameter of each of the holes 41 is designed to be larger than that of the nozzle 23 of the porous membrane cartridge 1 of the multiple cartridge Ac and to be smaller than that of the fit-in portion 22. In addition, a depth of the hole 41 is designed to be longer than a length of the nozzle 23 in a longitudinal direction thereof. Here an upper circumference of the hole 41 of the recovery container C corresponds to a fourth holding portion described in “DISCLOSURE OF THE INVENTION.” In addition, in the recovery container C are formed grooves 43 along the holes 41, respectively. The grooves 43 are ones for eliminating pressurized air.

In each of such the holes 41 is inserted the nozzle 23 of the multiple cartridge Ac fitted in the cartridge array frame B, and the upper circumference of the hole 41 of the recovery container C abuts with the top end of the fit-in portion 22.

In accordance with the present invention related to the third embodiment, because when passing liquid to be treated through each of the porous membrane cartridges 1 configuring the multiple cartridge Ac, the upper circumference of the hole 41 of the recovery container C abuts with the top end of the fit-in portion 22 and supports the multiple cartridge Ac, the multiple cartridge Ac does not bend by not less than 1 mm in a downward direction thereof even in case of a force of 12 N being applied toward the top end side from rear end side of the porous membrane cartridge 1; and thus a leakage of pressurized air can be prevented.

Meanwhile, the present invention is not limited to the technologies described in the first to third embodiments: it goes without saying that as far as the spirit and creation of technologies are same, they are included in the technical scope of the invention.

### EXAMPLE

Next will be described examples:

A multiple cartridge used here is 9 mm in a pitch of a porous membrane cartridge, 41 mm in a length of a vertical direction of the porous membrane cartridge, 8.5 mm in a barrel inner diameter, 0.7 mm in a thickness of a barrel and a cap, 1.2 mm in a thickness of a rib, and polypropylene in a material of the barrel and the cap. In addition, a link piece is a sheet-form body.

In addition, for the multiple cartridge, applying a force of 12 N to an opening of a rear end side thereof and introducing pressurized air of 1.5 KPa from the opening of the rear end side, tests described in Table 1 were performed five times for each example and comparison example regarding a bending amount of the multiple cartridge and a presence or absence of a leakage of the pressurized air.

TABLE 1

| | Linkage | | | | | |
|---|---|---|---|---|---|---|
| | Number | | | | | Presence |
| | of Porous | | | | | or |
| | Membrane | | | | Bending | Absence |
| | Cartridge | | | | Amount | of |
| | (piece) | L × t | L (mm) | t (mm) | (mm) | Leakage |
| Example 1 | 8 | 7 | 10 | 0.7 | 0.7 | X |
| Example 2 | 12 | 7 | 10 | 0.7 | 0.9 | X |
| Example 3 | 8 | 12 | 10 | 1.2 | 0.6 | X |
| Example 4 | 12 | 12 | 10 | 1.2 | 0.75 | X |
| Example 5 | 8 | 5 | 10 | 0.5 | 1 | X |
| Example 6 | 12 | 5 | 10 | 0.5 | 1.1 | Δ |
| Example 7 | 8 | 18 | 15 | 1.2 | 0.4 | X |
| Example 8 | 12 | 18 | 15 | 1.2 | 0.6 | X |
| Example 9 | 8 | | | | | X |
| Example 10 | 12 | | | | | X |
| Comparison | 8 | 3.5 | 7 | 0.5 | 1.5 | ♦ |
| Example 1 | | | | | | |
| Comparison | 12 | 3.5 | 7 | 0.5 | 1.8 | ♦ |
| Example 2 | | | | | | |

In the examples 9 and 10 was used each multiple cartridge as shown in FIG. 3 where a connection portion of each porous membrane cartridge is made thick: a symbol × shows a multiple cartridge where there is no leakage of pressurized air; a symbol Δ shows a multiple cartridge where there were both porous membrane cartridges some of which had a leakage of the pressurized air, and the others of which had no leakage of the pressurized air; and a symbols ♦ shows a multiple cartridge where there was the leakage of the pressurized air. In addition, “L” shows a length of a vertical direction of a link piece of a multiple cartridge; “t” shows a width of the link piece of the multiple cartridge.

As proved in FIG. 1, when “L×t” is not less than 5, a leakage of pressurized air is difficult to occur; when “L×t”, is not more than 3.5, the leakage of the pressurized air occurs. In addition, when a bending amount of a multiple cartridge is not more than 1 mm, a leakage of pressurized air does not occur; when the bending amount of the multiple cartridge is not less than 1.5 mm, the leakage of the pressurized air occurs.

### INDUSTRIAL APPLICABILITY

In accordance with the present invention, because if a porous membrane cartridge receives a force of 12 N in a downward direction thereof, a bending amount of a multiple cartridge in a vertical direction thereof can be prevented, a leakage of pressurized air can be prevented.

1. A multiple cartridge comprising:
a plurality of porous membrane cartridges for holding each porous membrane within a tube of a tubular body thereof, said plurality of the porous membrane cartridges being provided side by side in a row and integrally configured,
wherein said tubular body has an opening at a top end portion and rear end portion thereof; and
wherein when a force applied toward top end portions from rear end portions of said plurality of the porous membrane cartridges in 12 N, a bending amount of the multiple cartridge in a down ward direction thereof is not more than 1 mm.

2. A multiple cartridge of claim 1, wherein said porous membrane cartridge comprises:
a tubular barrel having an opening at a top end portion and rear end portion thereof;
a cap that is formed like a tube having a fit-in portion for fitting outside said top end portion, abuts with an opening edge of said top end portion, and has a sandwich face for sandwiching a porous membrane between said barrel and the cap;
and said porous membrane sandwiched between said opening edge of said barrel and said cap.

3. A multiple cartridge of claim 1, wherein an adjacent portion of each said porous membrane cartridge is linked by a link piece along a longitudinal direction of said tubular body.

4. A multiple cartridge of claim 2, wherein an adjacent portion of each said porous membrane cartridge is linked by a link piece along a longitudinal direction of said barrel or said cap.

5. A multiple cartridge of claim 1, wherein a connection portion of each said porous membrane cartridge is thickly formed.

6. A multiple cartridge of claim 1, wherein each adjacent said tubular body is integrally molded.

7. A multiple cartridge of claim 2, wherein each adjacent said barrel or each adjacent said cap is integrally molded.

8. A multiple cartridge of claim 3, wherein when assuming that a length of said link piece in a vertical direction is L (mm) and a thickness thereof is t (mm), L×t is not les than 5.

9. A multiple cartridge of claim 3, wherein when assuming that a length of said link piece in a vertical direction is L (mm) and a thickness thereof is t (mm), L×t is not less than 7.

10. A cartridge array frame for arraying in a plurality of rows multiple cartridges integrally configured by plurality of porous membrane cartridges for holding each porous membrane within a tube of a tubular body thereof, which has an opening at a top end portion and rear end portion thereof, the frame comprising:
a frame body having a rectangular opening, whose one pair of sides corresponds to a length in a horizontal d direction of each of said multiple cartridges;
a plurality of first holding portions that are provided inside the other pair of sides of said opening and hold a side portion of said multiple cartridge; and
a second holding portion that is provided inside one pair sides and/or the other pair of sides of said opening and holds a tubular body of said multiple cartridge.

11. A cartridge array frame for arraying in a plurality of rows multiple cartridges integrally configured by a plurality of porous membrane cartridges for holding each porous membrane whining a tube of tubular body thereof, which has an opening at a top end portion and rear end portion thereof, and for linking an adjacent portion of each of said porous membrane cartridges with a link piece along a longitudinal direction of said tubular body, being provided side by side in a row the frame comprising:
a frame body having a rectangular opening, whose one pair of sides corresponds to a length in a horizontal direction of each of said multiple cartridges;
a plurality of first holding portions that are provided inside the other pair of sides of said opening and hold a side portion of said multiple cartridge; and
a third holding portion that is provided inside one pair of sides and/or the other pair of sides of said opening and holds the tubular body of said multiple cart ridge.

12. A recovering container for recovering extraction liquid or an effluent discharged from matrix-like multiple cartridges arranged in a cartridge array frame where multiple cartridges, where porous membrane cartridges for holding each porous membrane within a tube of tubular body thereof having an opening at a top end portion and rear end portion thereof, are plurally provided side by side in a row and integrally configured, are arrayed in a plurality of rows, the container comprising:
a container body having a plurality of openings corresponding to said matrix-like multiple cartridges; and
a fourth holding portion for holding the tubular body of each of said multiple cartridges formed at edges of said openings.

13. A multiple cartridge of claim 2, wherein a connection portion of each said porous membrane cartridge is thickly formed.

14. A multiple cartridge of claim 4, wherein when assuming that a length of said link piece in a vertical direction is L (mm) and a thickness thereof is t (mm), L×t is not les than 5.

15. A multiple cartridge of claim 4, wherein when assuming that a length of said link piece in a vertical direction is L (mm) and a thickness thereof is t (mm), L×t is not less than 7.
